(19) United States
(12) Patent Application Publication
(10) Pub. No.: US 2026/0107259 A1
(43) Pub. Date: Apr. 16, 2026

(54) RESOURCE SELECTION METHOD AND USER EQUIPMENT, BASE STATION, STORAGE MEDIUM AND CHIP

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 19/115,082

(22) PCT Filed: Sep. 26, 2022
(86) PCT No.: PCT/CN2022/121489

§ 371 Date: Mar. 25, 2025

(51) Int. Cl. H04W 72/02; H04W 72/40; H04W 92/18

(52) U.S. Cl. CPC H04W 72/02; H04W 72/40; H04W 92/18

(57) ABSTRACT

A resource selection method and device, a user equipment, a base station, a storage medium, and a chip, relating to the technical field of communications. The method is applied to a user equipment, and comprises: in response to there being no transmission resource pool in received system information, performing sidelink transmission by means of a pre-configured transmission resource. By using the resource selection method provided by the present disclosure, when there is no transmission resource pool in system information, sidelink transmission can be performed by means of a pre-configured transmission resource, thereby avoiding interruption of communications and services of a user equipment.

### CROSS-REFERENCE

The present application is a U.S. National Stage of International Application No. PCT/CN2022/121489, filed on September 26, 2022, the contents of all of which are incorporated herein by reference in their entirety for all purposes.

### BACKGROUND OF THE INVENTION

In order to support the direct communication between user equipments (UEs), a sidelink communication mode is introduced, and the UEs can communicate with each other through PC-5 interfaces (direct communication interfaces). When a UE needs to communicate with a base station but is out of coverage of a base station network, the UE can communicate with the base station through a relay function of another UE within the coverage of the base station network. The UE which is not connected with the base station is called a remote UE, the UE which provides a relay function is called relay UE, and unicast, multicast, and broadcast communications can be performed between the remote UE and the relay UE through a sidelink.

### SUMMARY OF THE INVENTION

According to a first aspect of an embodiment of the present disclosure, a resource selection method is provided, which is performed by a user equipment, and the method includes:
using a pre-configured transmission resource for sidelink transmission in a case where a transmission resource pool in received system information is absent.

According to a second aspect of an embodiment of the present disclosure, a resource selection method is provided, which is performed by a base station, and the method includes:
obtaining a resource request from a user equipment by sidelink reception, where the resource request is transmitted by the user equipment using a pre-configured transmission resource in a case where a transmission resource pool in system information is absent.

According to a third aspect of an embodiment of the present disclosure, a user equipment is provided, which includes:
one or more processors; and
a memory that stores processor-executable instructions,
where the one or more processors are configured to perform the steps of the resource selection method provided in the first aspect of the embodiment of the present disclosure when executing the executable instructions.

According to a fourth aspect of an embodiment of the present disclosure, a base station is provided, which includes:
one or more processors; and
a memory that stores processor-executable instructions,
where the one or more processors are configured to perform the steps of the resource selection method provided in the second aspect of the embodiment of the present disclosure when executing the executable instructions.

According to a fifth aspect of an embodiment of the present disclosure, a non-transitory computer-readable storage medium is provided. The non-transitory computer-readable storage medium stores computer program instructions which, when executed by one or more processors, implement the steps of the resource selection method provided in the first aspect of the present disclosure or the steps of the resource selection method provided in the second aspect of the present disclosure.

According to a sixth aspect of an embodiment of the present disclosure, a chip is provided, which includes one or more processors and an interface; where the one or more processors are configured to read instructions to perform the steps of the resource selection method provided by the first aspect of the present disclosure or the steps of the resource selection method provided by the second aspect of the present disclosure.

It can be understood that the above general description and the following detailed description are merely illustrative and explanatory rather than limit the present disclosure.

### BRIEF DESCRIPTION OF DRAWINGS

The accompanying drawings, which are incorporated in the present specification and constitute a part of the present specification, illustrate embodiments conforming to the present disclosure, and are used to explain the principle of the present disclosure along with the present specification.

FIG. 1 shows a flowchart of a resource selection method according to an example.

FIG. 2 shows a flowchart of a resource selection method according to an example.

FIG. 3 shows a flowchart of a resource selection method according to an example.

FIG. 4 shows a flowchart of a resource selection method according to an example.

FIG. 5 shows a flowchart of a resource selection method according to an example.

FIG. 6 shows a flowchart of a resource selection method according to an example.

FIG. 7 shows a flowchart of a resource selection method according to an example.

FIG. 8 shows a flowchart of a resource selection method according to an example.

FIG. 9 shows a flowchart of a resource selection method according to an example.

FIG. 10 shows a flowchart of a resource selection method according to an example.

FIG. 11 shows a block diagram of a resource selection device according to an example.

FIG. 12 shows a block diagram of a resource selection device according to an example.

FIG. 13 shows a block diagram of a user equipment according to an example.

FIG. 14 shows a block diagram of a base station according to an example.

### DETAILED DESCRIPTION OF THE INVENTION

Reference will now be made in detail to the examples, examples of which are illustrated in the accompanying drawings. The following description refers to the accompanying drawings in which same numbers in different accompanying drawings represent same or similar elements, unless otherwise indicated. The implementations described in the following examples do not represent all implementations consistent with the present disclosure. Rather, they are merely examples of devices and methods consistent with certain aspects of the present disclosure, as detailed in the appended claims.

It should be noted that all the actions of acquiring signals, information or data in the present application are performed under the premise of complying with the corresponding data protection laws and policies of the countries where it is located and being authorized by corresponding device owners.

In the process of sidelink communication, the remote UE can use a transmission resource pool in system information for sidelink transmission. However, when no transmission resource pool exists in the system information, the remote UE has no available transmission resource pool for sidelink transmission, resulting in interruption of communication between the remote UE and the relay UE.

In order to overcome the problems existing in the prior art, the present disclosure provides a resource selection method and a user equipment, a base station, a storage medium, and a chip, relating to the technical field of communication.

FIG. 1 shows a flowchart of a resource selection method according to an example. As shown in FIG. 1, the resource selection method may be performed by a user equipment, the user equipment may be the aforementioned remote UE. The method includes step S101.

At Step S101, in a case where a transmission resource pool in received system information is absent, a pre-configured transmission resource is used for sidelink transmission.

For example, in order to support the direct communication between UEs, in the present embodiment, data communication is established between devices through the 5G (5^{th} Generation Mobile Communication System) or 4G (4^{th} Generation Mobile Communication System) communication technology, and based on a sidelink (SL) communication mode, direct communication may be performed between the UEs through PC-5 interfaces. According to a corresponding relationship between the UEs, unicast, multicast, and broadcast modes are supported on a sidelink. Transmitting UE transmits Sidelink Control Information (SCI) on a PSCCH (Physical Sidelink Control Channel) and a second-stage SCI on a PSSCH (Physical Sidelink Shared Channel), where the SCI carries a resource location for data transmission, a source UE identifier, a destination UE identifier, etc. After receiving the SCI, receiving UE determines, according to the source UE identifier and the destination UE identifier in the SCI, whether to receive corresponding data and which process is involved. In unicast connection, each UE corresponds to one destination identifier; in multicast connection, each UE may belong to one or more groups, and each group corresponds to one destination identifier; and in broadcast connection, all the UE correspond to at least one destination identifier.

There are two transmission resource allocation modes for sidelink communication. One is a network dynamic scheduling mode, and the other is an autonomous selection mode in which UE makes a selection from a resource pool broadcast by a base station by itself.

The network dynamic scheduling mode means that the base station dynamically allocates a transmission resource on the sidelink to a UE according to cached data reported the UE, and the UE may be a relay UE covered by a base station network.

The autonomous selection mode means that the UE randomly selects, by itself, a transmission resource from a transmission resource pool in system information, pre-configured transmission resources or transmission resources in a RRC (Radio Resource Control) reconfiguration message. For the system information, the base station may transmit the system information to the remote UE. For example, the base station may generate system information according to whether there are transmission resource pools in a network and which transmission resource pools exist in the network. The base station then broadcasts these system information, UEs covered by the base station network obtains the system information, these UEs may serve as relay UEs to forward the system information to the remote UEs; and when the remote UEs are in an idle or inactive state, the transmission resource pools in the system information broadcast by the base station can be used for sidelink transmission. As for the RRC reconfiguration message, the RRC reconfiguration message is a message generated by the base station according to a resource request reported by remote UE, the message carries a transmission resource returned by the base station to the remote UE; and when entering a connected state, the remote UE can use the transmission resource in the reconfiguration message for sidelink transmission. A pre-configured transmission resource is a transmission resource configured in advance at a remote UE, and when the remote UE is in an off-line state which includes the remote UE being not covered by the base station network, the remote UE can use the pre-configured transmission resource for sidelink transmission.

Both the transmission resources of the system information and the RRC reconfiguration message are transmitted by the base station, a pre-configured transmission resource pool is configured in advance in the UE, and the system information may be System Information Block Type 12 (SIB12).

It is worth noting that the transmission resource in the RRC reconfiguration message may be a transmission resource pool, and the UE can select at least one transmission resource from the transmission resource pool for sidelink transmission; and the pre-configured transmission resource may be a pre-configured transmission resource pool, and the UE can select at least one transmission resource from the pre-configured transmission resource pool for sidelink transmission.

It is worth noting that the transmission resource pool may be a relay sidelink transmission resource pool, and the transmission resources may be relay sidelink transmission resources. A relay sidelink includes a remote UE, a relay UE, and a base station, where the remote UE interacts with the base station via the relay UE. The relay sidelink transmission resources are sidelink transmission resources, and the relay sidelink transmission resource pool is a sidelink transmission resource pool.

The sidelink transmission resources are resource parameters in a time domain and a frequency domain. Each base station can schedule a sidelink transmission resource within a corresponding time period from the sidelink transmission resource pool through the time domain, and the corresponding sidelink transmission resource is determined from the sidelink transmission resource pool through the frequency domain band to meet the resource request from the UE. For example, taking the 4G communication technology as an example, a 4G base station schedules a sidelink transmission resource in a sidelink transmission resource pool through DCI (Downlink Control Information), where the time domain carried in the DCI is set as 10:00-11:00 and the frequency domain carried in the DCI as 1880 MHz-1900 MHz; and then a UE determines, according to the DCI, the sidelink transmission resource in a frequency domain band of 1880 MHz-1900 MHZ within the period of 10:00-11:00 as a feedback for a resource request transmitted by the UE.

The resource pool of the network dynamic scheduling mode and the resource pool of the autonomous selection mode are separated, and the transmission resources are centrally allocated by the base station in the network dynamic scheduling mode, so the collision between different UEs can be avoided through a reasonable algorithm.

The base station may carry the transmission resource pool in the system information, and the UE uses the transmission resource pool in the system information for autonomous selection. The transmission resource pool in the system information is divided into two types, one is a normal transmission resource pool (sl-TxPoolSelectedNormal), and the other is an exceptional transmission resource pool (sl-TxPoolExceptional). If the system information carries a normal transmission resource pool, the UE uses the normal transmission resource pool; if the system information does not carry a normal transmission resource pool, the UE uses an exceptional transmission resource pool; and if the system information does not carry any transmission resource pool, the UE needs to use the pre-configured transmission resource for sidelink transmission.

It is worth noting that transmission through a sidelink may be sidelink transmission, and the remote UE may carry data or instructions transmitted to the relay UE or the base station in the process of sidelink transmission and transmit them in the sidelink. For example, in the process of sidelink transmission, a resource request transmitted by the remote UE to the base station may be carried, or an RRC reconfiguration message transmitted by the base station to the remote UE may be carried.

It is worth noting that the user equipment proposed by any embodiment of the present disclosure may be a mobile phone, a tablet, a portable computer, a computer with a wireless transceiver function, a virtual reality (VR) terminal device, an augmented reality (AR) terminal device, a wireless terminal in industrial control, a wireless terminal in a smart grid, a wireless terminal in transportation safety, a wireless terminal in a smart city, a wireless terminal in a smart home, or the like. An application scenario is not limited by the present disclosure, and the user equipment may sometimes be called a terminal device, a terminal, an access terminal, a UE unit, a UE station, a mobile device, a mobile radio station, a mobile station, a mobile client, or the like.

It is worth noting that the pre-configured transmission resource may be configured in advance in the UE by developers, and the pre-configured transmission resource is a resource parameter in the time domain and the frequency domain, and the frequency domain band, time period, available duration and bandwidth, etc. of the transmission resource may be configured in advance in the UE.

The UE may obtain the system information broadcast by the base station, so that the relay UE located within the coverage of the base station network can obtain the system information broadcast by the base station. When the remote UE is in the off-line state, the relay UE may forward the obtained system information of the base station to the remote UE after transmitting a system information request to the relay UE through the pre-configured transmission resource; when the remote UE determines that the system information does not carry a transmission resource pool, sidelink transmission cannot be performed at this time; and in order to perform sidelink transmission, the pre-configured transmission resource can continue to be used for sidelink transmission.

Through the aforementioned solution, in the absence of the transmission resource pool in the system information, the remote UE can use the pre-configured transmission resource to continue sidelink transmission, so that the remote UE can perform data or signaling interaction with the relay UE or the base station, avoiding communication or service interruption of the remote UE.

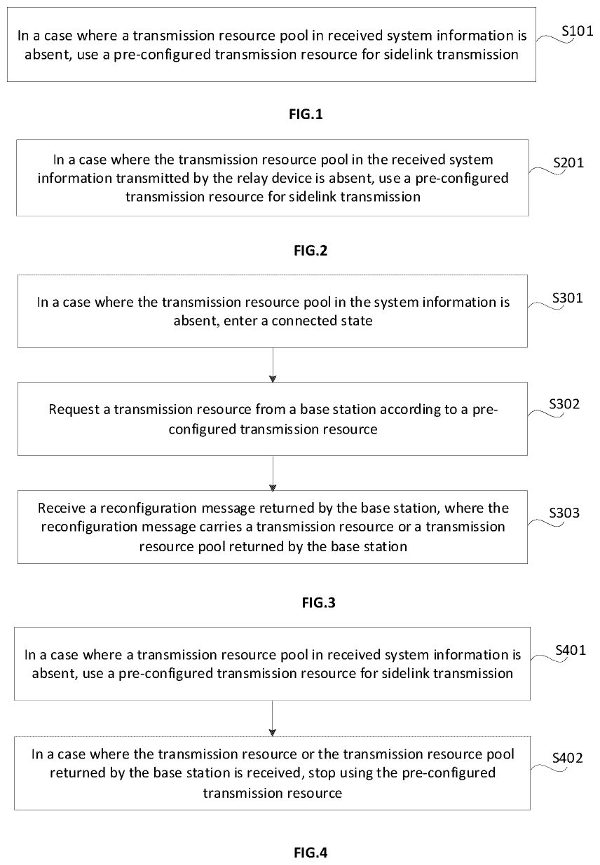

FIG. 2 shows a flowchart of a resource selection method according to an example. As shown in FIG. 2, the resource selection method is performed by a user equipment, and the method includes step S201.

At Step S201, in a case where the transmission resource pool in the received system information transmitted by the relay device is absent, the pre-configured transmission resource is used for sidelink transmission.

For example, this embodiment is performed by the user equipment, the user equipment may be the aforementioned remote UE interacting with the base station via the relay UE, and communication signals between the remote UE and the relay UE may be transmitted by sidelink unicasting; the relay device may be a relay UE, which is configured for establishing a communication connection between the remote UE and the base station, and the relay device is covered by the base station network.

For example, the base station may broadcast the system information through the network, and the relay UE covered by the base station network may receive the system information, so the remote UE can use a pre-configured transmission resource for sidelink transmission in a case where the transmission resource pool in the system information of the base station of the relay UE is absent. The remote UE receives the system information transmitted by the relay UE, the system information may be obtained by the relay UE from the base station.

It is worth noting that a coverage area of the base station network is a serving cell, and the relay UE may obtain the system information broadcast by the base station from the serving cell. The serving cell is an area covered by a base station or part of the base station in a communication system, and UEs in this area can communicate with each other through wireless channels.

It is worth noting that one UE may communicate with the base station via the relay function of the other UE rather than is directly connected with the base station, where the UE which is not connected with the base station is called the remote UE, the UE which provides a relay function is called the relay UE, and the remote UE and the relay UE communicate with each other in a unicast manner through a sidelink. This architecture is called U2N (UE to NW, User Equipment to Network) relay.

In the process of accessing the network via the relay UE, the remote UE can use the pre-configured transmission resource for sidelink transmission before obtaining the system information forwarded by the relay UE, so as to perform signaling and data interaction with the relay UE.

For example, the remote UE may transmit a system information request to the relay UE through the pre-configured transmission resource, where the system information request carries a requested system information identifier; and the relay UE determines the system information according to the system information identifier and returns the system information to the remote UE. The relay UE may obtain the system information broadcast by the base station.

It will be understood that the method may further include: receiving a system message, where the base station may broadcast the system message. When the base station network covers the remote UE, the remote UE directly receives the system message broadcast by the base station; and when the remote UE is not covered by the base station network, the system message may also be transmitted to the relay UE by the base station and forwarded to the remote UE by the relay UE, and this is not limited by the present disclosure.

Through the aforementioned technical solution, the remote UE may receive the system information obtained by the relay UE from the base station; and in a case where no transmission resource pool in the system information, the pre-configured transmission resource is used for sidelink transmission, so as to guarantee a communication connection between the remote UE and the relay UE and avoid communication and service interruption of the remote UE.

FIG. 3 shows a flowchart of a resource selection method according to an example. As shown in FIG. 3, the resource selection method is performed by user equipment, and the method includes steps S301-S303.

At Step S301, in a case where the transmission resource pool in the system information is absent, the remote UE enters a connected state.

For example, when the remote UE has received the system information and determines that there is no transmission resource pool in the system information, the remote UE enters the connected state.

The entry of the remote UE into the connected state indicates that the remote UE needs to perform data or signaling interaction with the relay UE or the base station, and the remote UE is in the off-line state.

At Step S302, a transmission resource is requested from the base station according to the pre-configured transmission resource.

For example, after the remote UE enters the connected state, in order to meet the requirement of data or signaling interaction between the remote UE and the relay UE or the base station, the remote UE may transmit a resource request to the relay UE by employing the pre-configured transmission resource in the remote UE, and the relay UE forwards the resource request to the base station.

Since the relay the base station network covers UE, the relay UE can forward the resource request transmitted by the remote UE to the base station; and the resource request is used to request a transmission resource from the base station, so that the remote UE can communicate with the base station or the relay UE by using the transmission resource allocated by the base station.

At Step S303, a reconfiguration message returned by the base station is received, where the reconfiguration message carries a transmission resource or a transmission resource pool returned by the base station.

For example, after receiving the resource request, the base station may generate the reconfiguration message carrying the transmission resource or the transmission resource pool to return the transmission resource or the transmission resource pool to the remote UE.

The reconfiguration message may be an RRC reconfiguration message, which is generated by the base station according to the resource request reported by the remote UE and is used to allocate the transmission resource or the transmission resource pool to the remote UE.

It will be understood that the method may further include: receiving a system message, where the base station may broadcast the system message. When the base station network covers the remote UE, the remote UE directly receives the system message broadcast by the base station; and when the remote UE is not covered by the base station network, the system message may also be transmitted to the relay UE by the base station and forwarded to the remote UE by the relay UE, and this is not limited by the present disclosure.

Through the aforementioned technical solution, the remote UE may receive the system information obtained by the relay UE from the base station; and when it is determined that there is no transmission resource pool in the system information, the pre-configured transmission resource is used for sidelink transmission, so as to guarantee the communication connection between the remote UE and the relay UE and avoid communication and service interruption of the remote UE.

FIG. 4 shows a flowchart of a resource selection method according to an example. As shown in FIG. 4, the resource selection method is performed by user equipment, and the method includes steps S401 and S402.

At Step S401, in a case where a transmission resource pool in received system information is absent, a pre-configured transmission resource is used for sidelink transmission.

For example, for Step S401 in the embodiment of the present disclosure, refer to Step S201 described above, which will not be repeated again.

At Step S402, in a case where the transmission resource or the transmission resource pool returned by the base station is received, the use of the pre-configured transmission resource is stopped.

For example, in a case where the remote UE has received the transmission resource or the transmission resource pool returned by the base station, it indicates that the remote UE may continue to perform data or signaling transmission with the base station or the relay UE by using the transmission resource requested from the base station, and at this point, the pre-configured transmission resource may be no longer used to perform data or signaling transmission with the base station or the relay UE.

After receiving the resource request transmitted by the remote UE, the base station may package the transmission resource or the transmission resource pool into reconfiguration information and return the reconfiguration information to the remote UE.

Through the aforementioned technical solution, in a case where the remote UE has received the transmission resource or the transmission resource pool carried in the reconfiguration message returned by the base station, it indicates that the remote UE has successfully requested the transmission resource from the base station, and at this point, the remote UE can use the transmission resource allocated by the base station for sidelink transmission without continuing to use the pre-configured transmission resource.

FIG. 5 shows a flowchart of a resource selection method according to an example. As shown in FIG. 5, the resource selection method is performed by a user equipment, and the method includes step S501.

At Step S501, in a case where the user equipment meets any of the following conditions, it is determined that the user equipment has been connected to the base station via the relay device:
the user equipment is not covered by the base station network;
a reference signal receiving power between the user equipment and the base station is less than a threshold;
the user equipment selects the relay device; or
the user equipment is configured with a direct link and an indirect link, and the indirect link serves as a main link, where the indirect link is a link for communication between the user equipment and the base station via the relay device.

When the remote UE is not covered by the base station network, it indicates that the remote UE has to connect with the base station through the relay UE, so as to interact with the base station, so when the remote UE is not covered by the base station network, the remote UE establishes a connection with the base station via the relay UE.

When the RSRP (Reference Signal Receiving Power) between the remote UE and the base station is less than the threshold, it indicates that a network signal received by the remote UE is poor and the remote UE cannot access the base station network, and at this point, the remote UE also establishes a connection with the base station via the relay UE.

The remote UE may be directly connected to the base station directly, or the remote UE may also be connected to the base station via the relay UE. When the remote UE selects one of a plurality of relay UEs to communicate with the base station, it indicates that the remote UE is connected with the base station via the relay UE.

For example, when the remote UE is not covered by the base station network or the RSRP between the remote UE and the base station is less than the threshold, it is determined that the remote UE may select the relay UE.

There also exists an SRB (Signaling Radio Bearer) main link and a plurality of SRB non-main links between the remote UE and the base station. When the indirect link serves as the SRB main link, it indicates that the indirect link among the remote UE, the relay UE, and the base station is a main link for data or signaling transmission. At this point, it can be determined that the remote UE is connected to the base station via the relay UE to transmit data or signal.

The remote UE is configured with at least one direct link and indirect link to communicate with the base station, where the direct link is a link which allows the remote UE to be directly connected to the base station, and the indirect link is a link which allows the remote UE to communicate with the base station via the relay UE. The indirect link may be determined as a main link according to any of the following conditions, and the direct link may also be determined as a main link according to any of the following conditions.

For example, the indirect link is determined as a main link according to any of the following conditions:
the indirect link is configured to transmit a signaling radio bearer, and the signaling radio bearer may be the SRB;
the indirect link is a main transmission path for transmitting the signaling radio bearer;
in a case where a connection of the indirect link fails, reconfiguration information of the base station is triggered;
the indirect link is a path for maintaining a connection between the user equipment and the base station;
the indirect link is an anchor path; or
the indirect link is connected with a master cell of the user equipment.

The indirect link used for SRB transmission includes an indirect link as a main transmission path used for SRB transmission and an indirect link as a non-main transmission path used for SRB transmission. When the indirect link is used for SRB transmission, it can be determined that the indirect link can be used for accessing the base station network, and at this point, it can be determined that the indirect link is a main link.

When the indirect link is the main transmission path used for SRB transmission, it can also be determined that the indirect link is used for accessing the base station network, and it can be determined that the indirect link is a main link.

The reconfiguration message is returned to the remote UE by the base station via the relay UE in a case where the remote UE is not covered by the base station network. After receiving the reconfiguration message, the remote UE will establish a connection with the base station according to the transmission resource or the transmission resource pool in the reconfiguration message, and the indirect link can implement main signaling or data forwarding, so the indirect link can serve as a main link.

When the indirect link is used for maintaining the connection between the remote UE and the base station, it means that the indirect link can implement signaling or data forwarding between the remote UE and the base station; while the other links may not be able to maintain the connection between the remote UE and the base station, which in turn is not able to implement signaling or data forwarding, so the indirect link may serve as a main link.

When the indirect link is an anchor path, because the anchor path is another name of the main path, the indirect path is the main path.

In dual-connectivity (DC), an access network device in control signaling interaction with a core network may be called a master node (MN), and other access network devices may be called secondary nodes (SNs). A serving cell group which is provided by the master node for the UEs can be called a master cell group (MCG), and serving cell groups which are provided by the secondary nodes for the terminal devices may be called secondary cell groups (SCGs). The master cells play a core control role, and the secondary cells are used for assisting the master cells to implement data transmission. When the indirect link is connected to a master cell of the remote UE, it means that the indirect link is a main control link, so the indirect link may serve as a main link.

Through the aforementioned technical solution, it can be determined that the UE is a remote UE which accesses the base station network via the relay UE; after the remote UE is determined, the remote UE confirms whether there is a transmission resource pool in the received system information; and if there is no transmission resource pool, the pre-configured transmission resource is used for sidelink transmission, so as to avoid communication and service interruption of the remote UE.

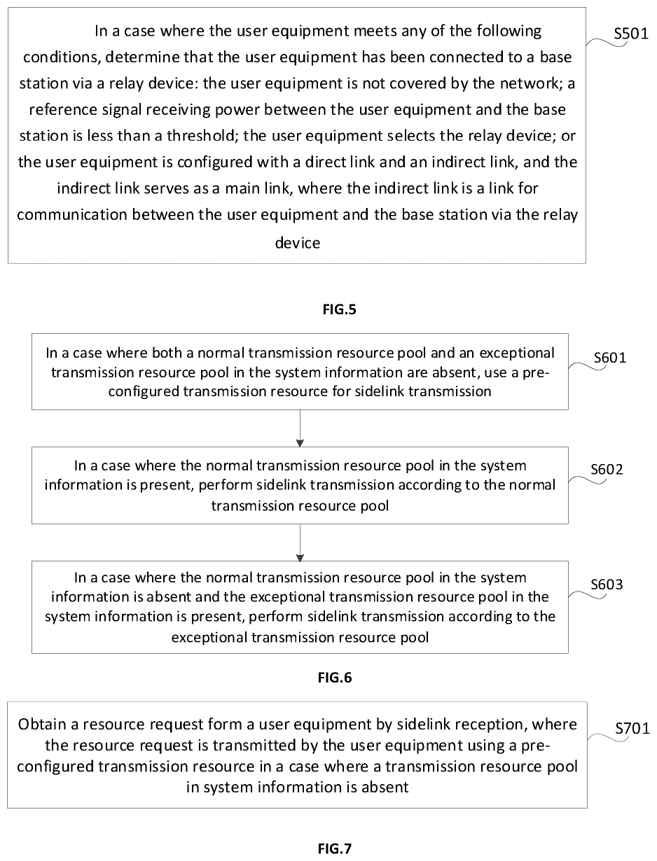

FIG. 6 shows a flowchart of a resource selection method according to an example. As shown in FIG. 6, the resource selection method is performed by a user equipment, and the method includes steps S601-S603.

At Step S601, in a case where both a normal transmission resource pool and an exceptional transmission resource pool in the system information are absent, the pre-configured transmission resource is used for sidelink transmission.

For example, the base station may generate system information according to whether there are transmission resource pools in the network and which transmission resource pools exist in the network. There may be both or one of the normal transmission resource pool and the exceptional transmission resource pool or no transmission resource pool in the system information. In a case where the remote UE determines that neither the normal transmission resource pool nor the exceptional transmission resource pool exists in the received system information, it can be determined that there is no transmission resource pool in the system information. In order to guarantee that the remote UE can perform sidelink transmission, the remote UE may use the pre-configured transmission resource for sidelink transmission.

At Step S602, in a case where the normal transmission resource pool in the system information is present, sidelink transmission is performed according to the normal transmission resource pool.

For example, in the presence of both the normal transmission resource pool and the exceptional transmission resource in the system information, or in the presence of the normal transmission resource pool in the system information, the remote UE prioritizes the use of the normal transmission resource pool for data or signaling interaction with the relay UE or the base station.

The remote UE may select at least one transmission resource from the normal transmission resource pool for sidelink transmission.

At Step S603, in a case where the normal transmission resource pool in the system information is absent and the exceptional transmission resource pool in the system information is present, sidelink transmission is performed according to the exceptional transmission resource pool.

For example, in the absence of the normal transmission resource pool and the presence of the exceptional transmission resource pool in the system information, the remote UE uses the exceptional transmission resource pool for data or signaling interaction with the relay UE or the base station.

The remote UE may select at least one transmission resource from the exceptional transmission resource pool for sidelink transmission.

Through the aforementioned technical solution, in a case where no transmission resource pool in the received system information and the remote UE may disconnect communication, the pre-configured transmission resource may be used for sidelink transmission, so as to guarantee normal communication of the remote UE.

FIG. 7 shows a flowchart of a resource selection method according to an example. As shown in FIG. 7, the resource selection method is performed by a base station, and the method includes step S701.

At Step S701, a resource request from a user equipment is obtained by sidelink reception, where the resource request is transmitted by the user equipment using a pre-configured transmission resource in a case where a transmission resource pool in system information is absent.

For example, the base station may be a base station for public mobile communication, such as the base station of the aforementioned serving cell, which may be a gNodeB in 5G.

Reception through a sidelink may be sidelink reception. In the process of sidelink reception, the base station may carry data or instructions for which the base station interacts with relay UE or remote UE for transmission in the sidelink. For example, in the process of sidelink reception, a resource request transmitted by the remote UE to the base station may be carried, an RRC reconfiguration message transmitted by the base station to the remote UE may be carried, or the like.

It is worth noting that the transmission resource pool may be a relay sidelink transmission resource pool, and the transmission resources may be relay sidelink transmission resources. A relay sidelink includes remote UE, relay UE, and a base station, where the remote UE interacts with the base station via the relay UE. The relay sidelink transmission resources are sidelink transmission resources, and the relay sidelink transmission resource pool is a sidelink transmission resource pool. These two types of transmission resources are used for communication between the UEs.

The resource request is transmitted by the user equipment using the pre-configured transmission resource in the absence of the transmission resource pool in the system information received from the relay device.

For example, the resource request is transmitted by the user equipment to the base station using the pre-configured transmission resource in the absence of the transmission resource pool in the system information of the base station of the relay device.

The base station may transmit a system information to the remote UE. The base station broadcasts the system information in the serving cell in a broadcasting manner, and the relay UE located in the serving cell transmits the system information to the remote UE, thus realizing that the remote UE receives the system information transmitted by the base station via the relay device.

Through the aforementioned solution, in the absence of the transmission resource pool in the system information, sidelink reception is performed to obtain a resource request transmitted by the user equipment using the pre-configured transmission resource, so that the remote UE can perform data or signaling interaction with the relay UE or the base station, avoiding communication or service interruption of the remote UE.

FIG. 8 shows a flowchart of a resource selection method according to an example. As shown in FIG. 8, the resource selection method is performed by a base station, and the method includes steps S801 and S802.

At Step S801, sidelink reception is performed to obtain a resource request, the resource request is transmitted by the user equipment using a pre-configured transmission resource after the user equipment enters a connected state.

For example, in a case where the remote UE receives the system information and determines that there is no transmission resource pool in the system information, the remote UE enters the connected state.

The entry of the remote UE into the connected state indicates that the remote UE needs to perform data or signaling interaction with the relay UE or the base station, and the remote UE is not covered by a network.

After the base station receives the resource request, it can be determined that the remote UE is offline, and communication or service interruption of the remote UE may occur.

At Step S802, a reconfiguration message is returned to the user equipment, where the reconfiguration message carries a transmission resource or a transmission resource pool returned by the base station.

After receiving the resource request, the base station may generate the reconfiguration message to allocate the transmission resource to the remote UE. The reconfiguration message may be an RRC reconfiguration message, which is generated by the base station in response to the resource request reported by the remote UE.

For example, there are two transmission resource allocation modes for communication, one is a network dynamic scheduling mode performed by the base station, and the other is an autonomous selection mode in which a UE makes a selection from a resource pool of a reconfiguration message, a pre-configured resource pool, or a resource pool of system information by itself.

In the dynamic scheduling mode, the UE transmits a resource request to the base station, and the base station determines to select the dynamic scheduling mode; after the dynamic scheduling mode is selected, the base station feeds back a dynamic scheduling instruction to the UE, where the dynamic scheduling instruction carries information which the UE needs to report; the UE transmits its own cached data to the base station according to the dynamic scheduling instruction; and the base station dynamically schedules a transmission resource according to the cached data, and returns the transmission resource to the UE, and the UE implements communication according to the transmission resource. The UE may be relay UE covered by a base station network.

In the autonomous selection mode, if there is a transmission resource pool of the system information at a remote UE side, then the remote UE selects a transmission resource from the transmission resource pool of the system information, so as to interact with the relay UE or the base station; if the system information received by the remote UE carries no transmission resource pool, then the remote UE may select a transmission resource from a pre-configured transmission resource pool, so as to interact with the relay UE and transmit a resource request to the base station via the relay UE; and the base station then generates a reconfiguration message according to the resource request reported by the remote UE, and transmits the reconfiguration message to the remote UE via the relay UE, where the reconfiguration message may carry the transmission resource or the transmission resource pool transmitted by the base station to the remote UE.

It is worth noting that the transmission resource or the transmission resource pool may be a data transmission resource, and data interaction between the remote UE and other devices can be implemented by using the transmission resource or the transmission resource pool.

Through the aforementioned technical solution, in the absence of the transmission resource pool in the system information, sidelink reception is performed to obtain a resource request transmitted by the user equipment using the pre-configured transmission resource, so that the remote UE can perform data or signaling interaction with the relay UE or the base station, avoiding communication or service interruption of the remote UE.

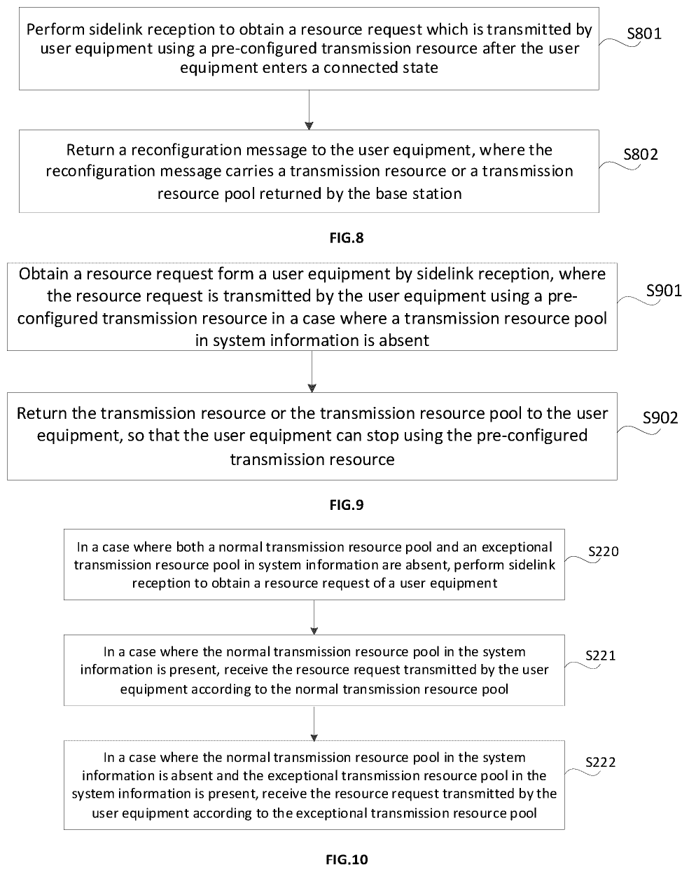

FIG. 9 shows a flowchart of a resource selection method according to an example. As shown in FIG. 9, the resource selection method is performed by a base station, and the method includes steps S901 and S902.

At Step S901, a resource request from a user equipment is obtained by sidelink reception, where the resource request is transmitted by the user equipment using a pre-configured transmission resource in a case where a transmission resource pool in system information is absent.

For example, for the method for sidelink reception in the embodiment of the present disclosure, refer to Step S801 described above, which will not be repeated again.

At Step S902, the transmission resource or the transmission resource pool is returned to the user equipment, so that the user equipment can stop using the pre-configured transmission resource.

For example, to stop using the pre-configured transmission resource in the embodiment of the present disclosure, refer to Step S402 described above, which will not be repeated.

Through the aforementioned technical solution, after the base station returns a reconfiguration message to the remote UE, it indicates that the remote UE has successfully requested a transmission resource from the base station, and at this point, the remote UE may use the transmission resource allocated by the base station to perform signaling or data transmission with the relay UE or the base station without continuing to use the pre-configured transmission resource.

A resource selection method according to an example, which a base station performs, includes: in a case where the user equipment meets any of the following conditions, it is determined that the user equipment has been connected to the base station via the relay device:
the user equipment is not covered by the base station network;
a reference signal receiving power between the user equipment and the base station is less than a threshold;
the user equipment selects the relay device; or
the user equipment is configured with a direct link and an indirect link, and the indirect link serves as a main link, where the indirect link is a link for communication between the user equipment and the base station via the relay device.

In a case where any of the following conditions is met, the indirect link servers as the main link:
the indirect link is used for transmitting a signaling radio bearer;
the indirect link is a main transmission path for transmitting the signaling radio bearer;
in a case where a connection of the indirect link fails, reconfiguration information of the base station is triggered;
the indirect link is a path for maintaining a connection between the user equipment and the base station;
the indirect link is an anchor path; or
the indirect link is connected with a master cell of the user equipment.

For example, for the conditions of determination of communication between the user equipment and the base station via the relay device in the embodiment of the present disclosure, refer to Step S501 described above, which will not be described again.

Through the aforementioned technical solution, it can be determined that the UE is remote UE which accesses the base station network via the relay UE; after the remote UE is determined, the remote UE confirms whether there is a transmission resource pool in the received system information; and if there is no transmission resource pool, the pre-configured transmission resource is used for sidelink transmission, so as to avoid communication and service interruption of the remote UE.

FIG. 10 shows a flowchart of a resource selection method according to an example. As shown in FIG. 10, the resource selection method is performed by a base station, and the method includes steps S220-S222.

At Step S220, in a case where both a normal transmission resource pool and an exceptional transmission resource pool in the system information are absent, sidelink reception is performed to obtain a resource request from the user equipment.

For example, for the determination of the resource request from the user equipment in the embodiment of the present disclosure, refer to Step S601 described above, which will not be repeated again.

At Step S221, in a case where a normal transmission resource pool in the system information is present, the resource request transmitted by the user equipment according to the normal transmission resource pool is received.

For example, for the normal transmission resource pool in the embodiment of the present disclosure, refer to Step S602 described above, which will not be repeated again.

At Step S222, in a case where the normal transmission resource pool in the system information is absent and the presence of the exceptional transmission resource pool in the system information is present, the resource request transmitted by the user equipment according to the exceptional transmission resource pool is received.

For example, for the exceptional transmission resource pool in the embodiment of the present disclosure, refer to Step S603 described above, which will not be repeated again.

Through the aforementioned technical solution, in a case where no transmission resource pool in the received system information and the remote UE may disconnect communication, the resource request which transmitted by the remote UE employing a pre-configured transmission resource can be received, so as to guarantee normal communication of the remote UE.

FIG. 11 shows a block diagram of a resource selection device according to an example. Referring to FIG. 11, the resource selection device 120 includes a resource request transmission module 121.

The resource request transmission module 121 is configured to use a pre-configured transmission resource for sidelink transmission in a case where a transmission resource pool in received system information is absent.

Alternatively, the user equipment is a remote device in a relay sidelink, and the user equipment communicates with the base station via a relay device. The resource request transmission module 121 includes:
a first resource request transmission module, configured to use the pre-configured transmission resource for sidelink transmission in a case where the transmission resource pool in the received system information transmitted by the relay device is absent.

Alternatively, the system information transmitted by the relay device is obtained from the base station connected with the relay device.

Alternatively, the resource request transmission module 121 includes:
a connection module, configured to enter a connected state in a case where the transmission resource pool in the system information is absent;
a second resource request transmission module, configured to request a transmission resource from the base station according to the pre-configured transmission resource; and
a reconfiguration message receiving module, configured to receive a reconfiguration message returned by the base station, where the reconfiguration message carries the transmission resource or the transmission resource pool returned by the base station.

Alternatively, the resource selection device 120 includes:
a first stopping module, configured to stop using the pre-configured transmission resource, in a case where the transmission resource or the transmission resource pool returned by the base station is received,.

Alternatively, the resource selection device 120 includes:
a first determining module, configured to determine that the user equipment is connected to the base station via the relay device, in a case where the user equipment meets any of the following conditions:
the user equipment is not covered by the base station network;
a reference signal receiving power between the user equipment and the base station is less than a threshold;
the user equipment selects the relay device; or
the user equipment is configured with a direct link and an indirect link, and the indirect link serves as a main link, where the indirect link is a link for communication between the user equipment and the base station via the relay device.

Alternatively, the resource selection device 120 includes:
a second determining module, configured to the indirect link serves as the main link in a case where any of the following conditions is met:
the indirect link is configured to transmit a signaling radio bearer;
the indirect link is a main transmission path for transmitting the signaling radio bearer;
in a case where a connection of the indirect link fails, reconfiguration information of the base station is triggered;
the indirect link is a path for maintaining a connection between the user equipment and the base station;
the indirect link is an anchor path; or
the indirect link is connected with a master cell of the user equipment.

Alternatively, the resource request transmission module 121 includes:
a third resource request transmission module, configured to use the pre-configured transmission resource for sidelink transmission in a case where both a normal transmission resource pool and an exceptional transmission resource pool in the system information are absent.

Alternatively, the resource selection device 120 includes:
a fourth resource request transmission module, configured to perform sidelink transmission according to a normal transmission resource pool in a case where the normal transmission resource pool in the system information is present; and
a fifth resource request transmission module, configured to perform sidelink transmission according to an exceptional transmission resource pool in a case where the normal transmission resource pool in the system information is absent and the exceptional transmission resource pool in the system information is present.

Alternatively, the transmission resource pool is a relay sidelink transmission resource pool, and the transmission resource is a relay sidelink transmission resource.

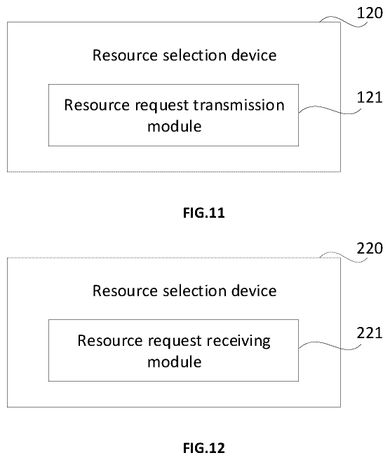

FIG. 12 shows a block diagram of a resource selection device according to an example. Referring to FIG. 12, the resource selection device 220 includes a resource request receiving module 221.
a resource request receiving module 221, configured to obtain a resource request from a user equipment by sidelink reception, where the resource request is transmitted by the user equipment using a pre-configured transmission resource in a case where a transmission resource pool in system information is absent.

Alternatively, the user equipment is a remote device in a relay sidelink, and the user equipment communicates with the base station via a relay device,
where the resource request is transmitted by the user equipment using the pre-configured transmission resource in a case where the transmission resource pool in the system information received from the relay device is absent.

Alternatively, the resource request is transmitted by the user equipment to the base station using the pre-configured transmission resource in a case where the transmission resource pool in the system information of the base station of the relay device is absent.

Alternatively, the resource request receiving module 221 includes:
a first resource request receiving module, configured to perform sidelink reception to obtain a resource request, where the resource request is transmitted by the user equipment using the pre-configured transmission resource after the user equipment enters a connected state; and
a reconfiguration message transmission module, configured to return a reconfiguration message to the user equipment, where the reconfiguration message carries a transmission resource returned by a base station or a transmission resource pool returned by the base station.

Alternatively, the resource selection device 220 includes:
a second stopping module, configured to return the transmission resource or the transmission resource pool to the user equipment for the user equipment to stop using the pre-configured transmission resource.

Alternatively, the resource selection device 220 includes:
a third determining module, configured to determine that the user equipment is connected to the base station via the relay device, in a case where the user equipment meets any of the following conditions:
the user equipment is not covered by the base station network;
a reference signal receiving power between the user equipment and the base station is less than a threshold;
the user equipment selects the relay device; or
the user equipment is configured with a direct link and an indirect link, and the indirect link serves as a main link, where the indirect link is a link for communication between the user equipment and the base station via the relay device.

Alternatively, the resource selection device 220 includes:
a fourth determining module, configured to the indirect link serves as the main link in a case where any of the following conditions is met:
the indirect link is configured to transmit a signaling radio bearer;
the indirect link is a main transmission path for transmitting the signaling radio bearer;
in a case where a connection of the indirect link fails, reconfiguration information of the base station is triggered;
the indirect link is a path for maintaining a connection between the user equipment and the base station;
the indirect link is an anchor path; or
the indirect link is connected with a master cell of the user equipment.

Alternatively, the resource request receiving module 221 includes:
a second resource request receiving module, configured for performing sidelink reception to obtain a resource request from the user equipment in a case where both a normal transmission resource pool and an exceptional transmission resource pool in the system information are absent.

Alternatively, the resource request receiving module 221 includes:
a third resource request receiving module, configured to receive the resource request transmitted by the user equipment according to a normal transmission resource pool in a case where the normal transmission resource pool in the system information is present; and
a fourth resource request receiving module, configured to receive the resource request transmitted by the user equipment according to an exceptional transmission resource pool in a case where the normal transmission resource pool in the system information is absent and the presence of the exceptional transmission resource pool in the system information is present.

Alternatively, the transmission resource pool is a relay sidelink transmission resource pool, and the transmission resource is a relay sidelink transmission resource.

Alternatively, the resource selection device 220 includes:
a system information transmission module, configured to transmit system information to the user equipment.

With regard to the devices in the aforementioned embodiments, the specific way in which each module performs operations has been described in detail in the embodiments of the related methods, and will not be described in detail here.

The present disclosure further provides a non-transitory computer-readable storage medium on which computer program instructions are stored, where when the program instructions are executed by a processor, the steps of the resource selection methods provided by the present disclosure are implemented.

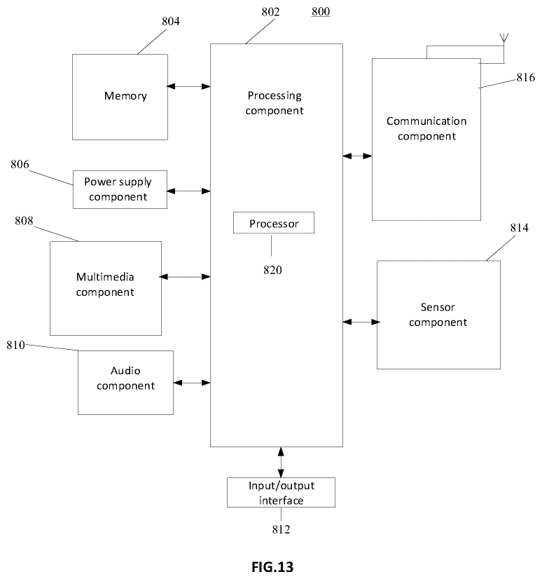

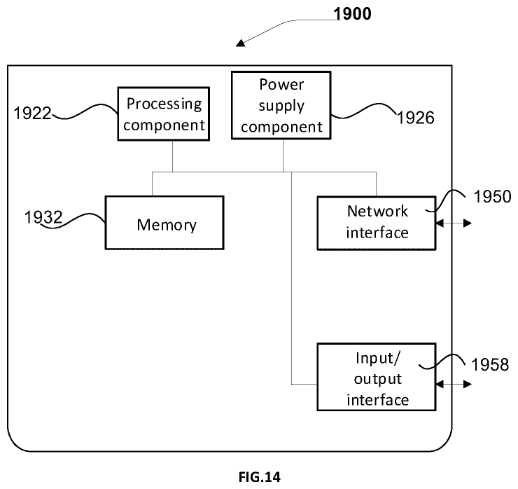

FIG. 13 is a block diagram of a device 800 as user equipment according to an example. For example, the device 800 may be a mobile phone, a computer, a digital broadcasting terminal, a messaging device, a game console, a tablet device, a medical device, a fitness device, a personal digital assistant, etc.

Referring to FIG. 13, the device 800 may include one or more of the following components: a processing component 802, a memory 804, a power supply component 806, a multimedia component 808, an audio component 810, an input/output interface 812, a sensor component 814, or a communication component 816.

The processing component 802 generally controls an overall operation of the device 800, such as operations associated with display, telephone calls, data communication, a camera operation, or a recording operation. The processing component 802 may include one or more processors 820 to execute instructions to execute all or part of the steps of the aforementioned methods. In addition, the processing component 802 may include one or more modules to facilitate interaction between the processing component 802 and the other components. For example, the processing component 802 may include a multimedia module to facilitate interaction between the multimedia component 808 and the processing component 802.

The memory 804 is configured to store various types of data to support operations at device 800. Examples of these data include instructions for any application program or method operating at the device 800, contact data, phonebook data, messages, pictures, videos, etc. The memory 804 may be implemented by any type of volatile or nonvolatile storage device or a combination of these storage devices, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or a compact disk.

The power supply component 806 supplies power to the various components of the device 800. The power supply component 806 may include a power management system, one or more power supplies, and other components associated with generating, managing and distributing power for the device 800.

The multimedia component 808 includes a screen providing an output interface between the device 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, sliding, and gestures on the touch panel. The touch sensor may not only sense a boundary of a touch or sliding action, but also detect a duration and a pressure related to the touch or sliding operation. In some embodiments, the multimedia component 808 includes a front camera and/or a rear camera. When the device 800 is in an operation mode, such as a shooting mode or a video mode, the front camera and/or the rear camera can receive external multimedia data. Each of the front camera and the rear camera may be a fixed optical lens system or has a focal length and optical zoom capability.

The audio component 810 is configured for outputting and/or inputting audio signals. For example, the audio component 810 includes a microphone (MIC), which is configured for receiving external audio signals when the device 800 is in the operation mode, such as a call mode, a recording mode, and a voice recognition mode. The received audio signals may be further stored in the memory 804 or sent via the communication component 816. In some embodiments, the audio component 810 further includes a speaker for outputting audio signals.

The input/output interface 812 provides an interface between the processing component 802 and peripheral interface modules, and the peripheral interface modules may be a keyboard, a click wheel, buttons, etc. These buttons may include, but are not limited to, a home button, volume buttons, a start button, and a lock button.

The sensor component 814 includes one or more sensors configured to provide various aspects of state estimation for device 800. For example, the sensor component 814 may detect the on/off state of the device 800 and relative positioning of components (such as a display and a keypad of the device 800); and the sensor component 814 may also detect a position change of the device 800 or one component of the device 800, whether the user contacts with the device 800, an orientation or acceleration/deceleration of the device 800, and a temperature change of the device 800. The sensor component 814 may include a proximity sensor, which is configured for detecting the presence of a nearby object without any physical contact. The sensor component 814 may further include an optical sensor (such as a CMOS or CCD image sensor) for use in imaging applications. In some embodiments, the sensor component 814 may further include an acceleration sensor, a gyro sensor, a magnetic sensor, a pressure sensor, or a temperature sensor.

The communication component 816 is configured for facilitating wired or wireless communication between the device 800 and another devices. The device 800 may access a wireless network based on communication standards, such as WiFi, 2G, 3G, or their combination. In an example, the communication component 816 receives broadcast signals or broadcast related information from an external broadcast management system via a broadcast channel. In an example, the communication component 816 further includes a near field communication (NFC) module to facilitate short-range communication. For example, the NFC module may be implemented based on a radio frequency identification (RFID) technology, an infrared data association (IrDA) technology, a ultra-wideband (UWB) technology, a Bluetooth (BT) technology, and other technologies.

In an example, the device 800 may be implemented by one or more application-specific integrated circuits (ASIC), a digital signal processor (DSP), a digital signal processing device (DSPD), a programmable logic device (PLD), a field programmable gate array (FPGA), a controller, a microcontroller, a microprocessor, or other electronic components, and is configured for performing the aforementioned methods.

In an example, there is also provided a non-transitory computer-readable storage medium including instructions, such as the memory 804 including instructions, where the aforementioned instructions may be executed by the processor 820 of the device 800 to execute the aforementioned methods. For example, the non-transitory computer-readable storage medium may be an ROM, a random access memory (RAM), a CD-ROM, a magnetic tape, a floppy disk, or an optical data storage device.

The aforementioned device may be a self-contained electronic device or part of the self-contained electronic device. For example, in one embodiment, the device may be an Integrated Circuit (IC) or a chip, where the integrated circuit may be an IC or a set of a plurality of ICs; and the chip may include, but is not limited to, the following types: a GPU (Graphics Processing Unit), a CPU (Central Processing Unit), an FPGA (Field Programmable Gate Array, programmable logic array), a DSP (Digital Signal Processor), an ASIC (Application Specific Integrated Circuit), an SoC(System on Chip), etc. The aforementioned integrated circuit or chip may be configured for executing executable instructions (or codes), so as to implement the aforementioned resource selection methods. The executable instructions may be stored in the integrated circuit or chip, or acquired from other devices or equipment. For example, the integrated circuit or chip includes a processor, a memory, and an interface for communication with other devices. The executable instructions may be stored in the memory, and when the executable instructions are executed by the processor, the aforementioned resource selection methods are implemented. Alternatively, the integrated circuit or chip may receive the executable instructions through the interface and transmit the executable instructions to the processor for execution, so as to implement the aforementioned resource selection methods.

As used herein, the term processor may refer to one processor that performs the defined functions or a plurality of processors that collectively perform defined functions, such that the execution of the individual defined functions may be divided amongst such processors.

In another example, there is also provided a computer program product, which includes a computer program executable by a programmable device, where the computer program is provided with a code portion which is configured for executing the aforementioned resource selection methods when executed by the programmable device.

FIG. 14 shows a block diagram of a base station 1900 according to an example. For example, the base station 1900 may be provided as a base station. Referring to FIG. 14, the base station 1900 includes a processing component 1922 which further includes one or more processors and a memory resource represented by a memory 1932 that is configured for storing instructions that may be executed by the processing component 1922, such as an application program. The application program stored in the memory 1932 may include one or more modules corresponding to a set of instructions. In addition, the processing component 1922 is configured to execute the instructions to perform the aforementioned resource selection methods.

The base station 1900 may further include a power supply component 1926 configured for performing power management on the base station 1900, a wired or wireless network interface 1950 configured for connecting the base station 1900 to a network, and an input/output interface 1958.

An embodiment of the present disclosure further provides a communication system, which includes a remote UE, an opposite UE of the remote UE, and a relay UE, where the remote UE and the opposite UE are each other's remote UE. The remote UE and the relay UE may perform the aforementioned resource selection methods.

Those skilled in the art will easily think of other embodiments of the present disclosure after considering the present specification and practicing the present disclosure. The present application is intended to cover any variation, use, or adaptation of the present disclosure, which follows the general principle of the present disclosure and includes the common knowledge or conventional technical means in the art that the present disclosure has not disclosed. The present specification and the embodiments are to be regarded as illustrative only, and the following claims indicate the true scope and spirit of the present disclosure.

It will be understood that the present disclosure is not limited to the precise structure described above and shown in the accompanying drawings, and various modifications and changes can be made without departing from its scope. The scope of the present disclosure is limited only by the appended claims.

1. A method for resource selection, performed by a user equipment (UE), the method comprising:
using a pre-configured transmission resource for sidelink transmission in a case where a transmission resource pool in received system information is absent.

2. The method according to claim 1, wherein the user equipment is a remote device in a relay sidelink, and the user equipment communicates with a base station via a relay device; and using the pre-configured transmission resource for sidelink transmission in a case where the transmission resource pool in the received system information is absent comprises:
using the pre-configured transmission resource for sidelink transmission in a case where the transmission resource pool in the received system information transmitted by the relay device is absent.

3. The method according to claim 2, wherein the system information transmitted by the relay device is obtained from the base station connected with the relay device.

4. The method according to claim 1, wherein using the pre-configured transmission resource for sidelink transmission in a case where the transmission resource pool in the received system information is absent comprises:
entering a connected state in a case where the transmission resource pool in the system information is absent;
requesting a transmission resource from base station according to the pre-configured transmission resource; and
receiving a reconfiguration message returned by the base station, wherein the reconfiguration message carries a transmission resource returned by the base station or a transmission resource pool returned by the base station.

5. The method according to claim 1, further comprising:
stopping using the pre-configured transmission resource in a case where the transmission resource returned by a base station or the transmission resource pool returned by the base station is received.

6. The method according to claim 2, further comprising:
determining that the user equipment is connected to the base station via the relay device, in a case where the user equipment meets any of conditions:
the user equipment is not covered by a network of the base station;
a reference signal receiving power between the user equipment and the base station is less than a threshold;
the user equipment selects the relay device; or
the user equipment is configured with a direct link and an indirect link, and the indirect link serves as a main link, wherein the indirect link is a link for communication between the user equipment and the base station via the relay device.

7. The method according to claim 6, wherein the indirect link serves as the main link in a case where any of conditions is met:
the indirect link is configured to transmit signaling radio bearer;
the indirect link is a main transmission path for transmitting the signaling radio bearer;
reconfiguration information of the base station is triggered in a case where a connection of the indirect link fails;
the indirect link is a path for maintaining a connection between the user equipment and the base station;
the indirect link is an anchor path; or
the indirect link is connected with a master cell of the user equipment.

8. The method according to claim 1, wherein using the pre-configured transmission resource for sidelink transmission in a case where the transmission resource pool in received system information is absent comprises:
using the pre-configured transmission resource for sidelink transmission in a case where both a normal transmission resource pool and an exceptional transmission resource pool in the system information are absent.

9. The method according to claim 1, further comprising:
performing sidelink transmission according to a normal transmission resource pool in a case where the normal transmission resource pool in the system information is present; and
performing sidelink transmission according to an exceptional transmission resource pool in a case where the normal transmission resource pool in the system information is absent and the exceptional transmission resource pool in the system information is present.

10. The method according to claim 1, wherein the transmission resource pool is a relay sidelink transmission resource pool, and the transmission resource is a relay sidelink transmission resource.

11. A resource method for resource selection performed by a base station, comprising:
obtaining a resource request from a user equipment by sidelink reception, wherein the resource request is transmitted by the user equipment using a pre-configured transmission resource in a case where a transmission resource pool in system information is absent.

12. The method according to claim 11, wherein the user equipment is a remote device in a relay sidelink, and the user equipment communicates with the base station via a relay device;
the resource request is transmitted by the user equipment using the pre-configured transmission resource in a case where the transmission resource pool in the system information received from the relay device is absent.

13. (canceled)

14. The method according to claim 11, wherein obtaining the resource request from the user equipment by sidelink reception comprises:
performing sidelink reception to obtain a the resource request, wherein the resource request is transmitted by the user equipment using the pre-configured transmission resource after the user equipment enters a connected state; and
returning a reconfiguration message to the user equipment, wherein the reconfiguration message carries a transmission resource returned by the base station or a transmission resource pool returned by the base station.

15. The method according to claim 11, further comprising:
returning a transmission resource or the transmission resource pool to the user equipment for the user equipment to stop using the pre-configured transmission resource.

16. The method according to claim 12, wherein determining that the user equipment is connected to the base station via the relay device, in a case where the user equipment meets any of conditions:
the user equipment is not covered by a network of the base station;
a reference signal receiving power between the user equipment and the base station is less than a threshold;
the user equipment selects the relay device; or
the user equipment is configured with a direct link and an indirect link, and the indirect link serves as a main link, wherein the indirect link is a link for communication between the user equipment and the base station via the relay device.

17. (canceled)

18. The method according to claim 11, wherein obtaining the resource request from the user equipment by sidelink reception comprises:
performing sidelink reception to obtain a the resource request from the user equipment in a case where both a normal transmission resource pool and an exceptional transmission resource pool in the system information are absent.

19. The method according to claim 11, further comprising:
receiving the resource request transmitted by the user equipment according to a normal transmission resource pool in a case where the normal transmission resource pool in the system information is present; and
receiving the resource request transmitted by the user equipment according to an exceptional transmission resource pool in a case where the normal transmission resource pool in the system information is absent and the exceptional transmission resource pool in the system information is present.

20-23. (canceled)

24. A user equipment, comprising:
one or more processors; and
a memory that stores processor-executable instructions,
wherein the one or more processors are configured to:
use a pre-configured transmission resource for sidelink transmission in a case where a transmission resource pool in received system information is absent.

25. A communication device, comprising:
one or more processors; an
a memory that stores processor-executable instructions,
wherein the one or more processors are configured cause the communication device to act as the base station and perform the method according to claim 11.

26. A non-transitory computer-readable storage medium, storing a computer program, wherein the computer program, when executed by one or more processors of the UE cause the UE to perform, the method according to claim 1.

27. (canceled)
